(19) United States
(12) Patent Application Publication
(10) Pub. No.: US 2010/0254576 A1
(43) Pub. Date: Oct. 7, 2010

(54) DIGITAL PHOTOGRAPHING APPARATUS, METHOD OF CONTROLLING THE SAME, AND RECORDING MEDIUM STORING PROGRAM TO IMPLEMENT THE METHOD

(76) Inventor: Sung-ha Park, Suwon-si (KR)

Correspondence Address: DRINKER BIDDLE & REATH LLP;ATTN: PATENT DOCKET DEPT., 191 N. WACKER DRIVE, SUITE 3700, CHICAGO, IL, 60606, US

(21) Appl. No.: 12/721,778

(22) Filed: Mar. 11, 2010

(30) Foreign Application Priority Data
Apr. 6, 2009 (KR) 10-2009-0029483

(51) Int. Cl. G06K 9/00; H04N 5/228

(52) U.S. Cl. 382/118; 348/222.1

(57) ABSTRACT

A digital photographing apparatus generates first image data including a first image and second image data including a second image that is obtained by displaying information onto the first image. The information may be stored in a database and may be related to a face recognized in the first image, related to a location at which the first image was obtained, or input by a user. The digital photographing apparatus stores the first image data and the second image data as one file to improve a user's convenience. The digital photographing apparatus may include an imaging device that generates first image data from incident light, a face recognition unit that determines whether a face is included in a first image of the first image data, a database storage medium that stores a database having information about faces in the first image, a face information search unit that searches for the information about a face included in the first image from the database, a sub-image generation unit that generates second image data including a second image that is obtained by displaying the information found by the face information search unit onto the first image, a multi-picture file generation unit that generates one multi-picture file including the first image data and the second image data, and an image data storage medium that stores the multi-picture file.

### CROSS-REFERENCE TO RELATED PATENT APPLICATION

This application claims the priority benefit of Korean Patent Application No. 10-2009-0029483, filed on Apr. 6, 2009, in the Korean Intellectual Property Office, the disclosure of which is incorporated herein in its entirety by reference.

### BACKGROUND

1. Field of the Invention

The present invention relates to a digital photographing apparatus, a method of controlling the same, and a recording medium storing a program to implement the controlling method, and more particularly, to a digital photographing apparatus that generates second image data by adding information to a first image obtained from first image data and stores the first image data and the second image data in a file in order to improve user's convenience, a method of controlling the digital photographing apparatus, and a recording medium storing a program to implement the controlling method.

2. Description of the Related Art

In general, digital photographing apparatuses obtain image data from light incident onto an image capture device, and store the obtained image data in a storage medium or display an image of the image data on a display unit.

When images are captured by using a digital photographing apparatus, human faces may be included in the obtained images. However, as time goes by, a user of the digital photographing apparatus may not be able to obtain information about persons included in the images or may not remember the persons included in the images. In addition, the user may not remember the spot (region) where the images were captured.

### SUMMARY

A digital photographing apparatus generates first image data including a first image and second image data including a second image that is obtained by adding information displayed onto the first image. The information may be stored in a database and may be related to a face recognized in the first image, related to a location at which the first image was obtained, or input by a user. The digital photographing apparatus stores the first image data and the second image data in a single file in order to improve user's convenience.

According to an aspect of the present invention, a digital photographing apparatus includes an imaging device that generates first image data from incident light, a face recognition unit that determines whether a face is included in a first image of the first image data generated by the imaging device, a database storage medium that stores a database having information about faces, a face information search unit that searches for information about the face included in the first image of the first image data generated by the imaging device from the database stored in the database storage medium, a sub-image generation unit that generates second image data including a second image that is obtained by adding the information found by the face information search unit onto the first image, a multi-picture file generation unit that generates one multi-picture file including the first image data generated by the imaging device and the second image data generated by the sub-image generation unit, and an image data storage medium that stores the multi-picture file generated by the multi-picture file generation unit.

When the face information search unit does not find information about the face included in the first image of the first image data generated by the imaging device from the database stored in the database storage medium, the sub-image generation unit may generate second image data of a second image obtained by adding information input from a user of the digital photographing apparatus to the first image.

According to another aspect of the present invention, a digital photographing apparatus includes an imaging device that generates first image data from incident light, a location data acquisition unit that acquires data of a location where the imaging device obtains the first image data, a database storage medium that stores a database including information about locations, a location information search unit that searches for information about a location corresponding to the location data acquired by the location data acquisition unit from the database stored in the database storage medium, a sub-image generation unit that generates second image data of a second image that is obtained by adding the information found by the location information search unit onto the first image of the first image data generated by the imaging device, a multi-picture file generation unit that generates one multi-picture file including the first image data generated by the imaging device and the second image data generated by the sub-image generation unit, and an image data storage medium that stores the multi-picture file generated by the multi-picture file generation unit.

When the location information search unit does not find information about a location corresponding to the location data acquired by the location data acquisition unit from the database stored in the database storage medium, the sub-image generation unit may generate second image data of a second image obtained by adding information input from a user of the digital photographing apparatus onto the first image.

According to another aspect of the present invention, a digital photographing apparatus includes an imaging device that generates first image data from incident light, a database storage medium that stores a database including information, an information search unit that searches for information related to a first image in the first image data generated by the imaging device from the database stored in the database storage medium, a sub-image generation unit that generates second image data of a second image that is obtained by adding the information found by the information search unit onto the first image of the first image data generated by the imaging device, a multi-picture file generation unit that generates one multi-picture file including the first image data generated by the imaging device and the second image data generated by the sub-image generation unit, and an image data storage medium that stores the multi-picture file generated by the multi-picture file generation unit.

When the information search unit does not find information about the first image from the database stored in the database storage medium, the sub-image generation unit may generate second image data of a second image obtained by adding information input from a user of the digital photographing apparatus onto the first image.

According to another aspect of the present invention, a method of controlling a digital photographing apparatus includes obtaining first image data from light incident onto an imaging device, and determining whether a face is included in a first image of the first image data. When a face is included in the first image, the method may further include determining whether information about the face included in the first image exists in a database. When information about the face exists in the database, the method may further include generating second image data relating to a second image that is obtained by adding the information on the first image, generating one multi-picture file including the first image data and the second image data, and storing the multi-picture file in an image data storage medium.

When information about the face does not exist in the database in the step of determining whether information about the face exists in the database, the method may further include generating second image data about a second image that is obtained by adding information input from a user of the digital photographing apparatus onto the first image, generating one multi-picture file including the first image data and the second image data, and storing the multi-picture file in an image data storage medium.

According to another aspect of the present invention, a method of controlling a digital photographing apparatus includes obtaining first image data from light incident onto an imaging device, obtaining data of a location where the first image data is obtained, and determining whether information about the location corresponding to the location data exists in a database. When information about the location exists in the database, the method may further include generating second image data relating to a second image that is obtained by adding the information onto the first image, generating one multi-picture file including the first image data and the second image data, and storing the multi-picture file in an image data storage medium.

When information about the location does not exist in the database in the step of determining whether information about the location exists in the database, the method may further include generating second image data about a second image that is obtained by adding information input from a user of the digital photographing apparatus onto the first image, generating one multi-picture file including the first image data and the second image data, and storing the multi-picture file in an image data storage medium.

According to another aspect of the present invention, a method of controlling a digital photographing apparatus includes obtaining first image data from light incident onto an imaging device, generating second image data about a second image that is obtained by adding information onto the first image, generating one multi-picture file including the first image data and the second image data, and storing the multi-picture file in an image data storage medium.

The generating of the second image data may include generating the second image data about the second image obtained by adding information read from a database onto the first image.

The generating of the second image data may include generating the second image data about the second image obtained by adding information input from a user of the digital photographing apparatus onto the first image.

According to another aspect of the present invention, a computer readable storage medium has stored thereon a program executable by a processor for performing any of the above methods of controlling the digital photographing apparatus.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of a digital photographing apparatus according to an embodiment of the present invention;

FIG. 2 is a schematic block diagram of a portion of the digital photographing apparatus illustrated in FIG. 1, according to the embodiment of the present invention;

FIG. 3A is a conceptual diagram schematically illustrating a first image acquired using the digital photographing apparatus of FIG. 1;

FIGS. 3B through 3D are conceptual diagrams schematically illustrating second images generated by the digital photographing apparatus of FIG. 1;

FIG. 4 is a conceptual diagram schematically illustrating a structure of a multi-picture file stored in an image data storage medium by the digital photographing apparatus of FIG. 1;

FIG. 5 is a flowchart illustrating a method of controlling the digital photographing apparatus of FIG. 1, according to an embodiment of the present invention;

FIG. 6 is a block diagram of a digital photographing apparatus, according to another embodiment of the present invention;

FIG. 7 is a schematic block diagram of a portion of the digital photographing apparatus illustrated in FIG. 6, according to an embodiment of the present invention;

FIG. 8A is a conceptual diagram schematically illustrating a first image acquired using the digital photographing apparatus of FIG. 6;

FIG. 8B is a conceptual diagram schematically illustrating a second image generated by the digital photographing apparatus of FIG. 6; and

FIG. 9 is a flowchart illustrating a method of controlling the digital photographing apparatus illustrated in FIG. 6, according to an embodiment of the present invention.

### DETAILED DESCRIPTION

Hereinafter, exemplary embodiments of the invention will be described in detail with reference to the appended drawings.

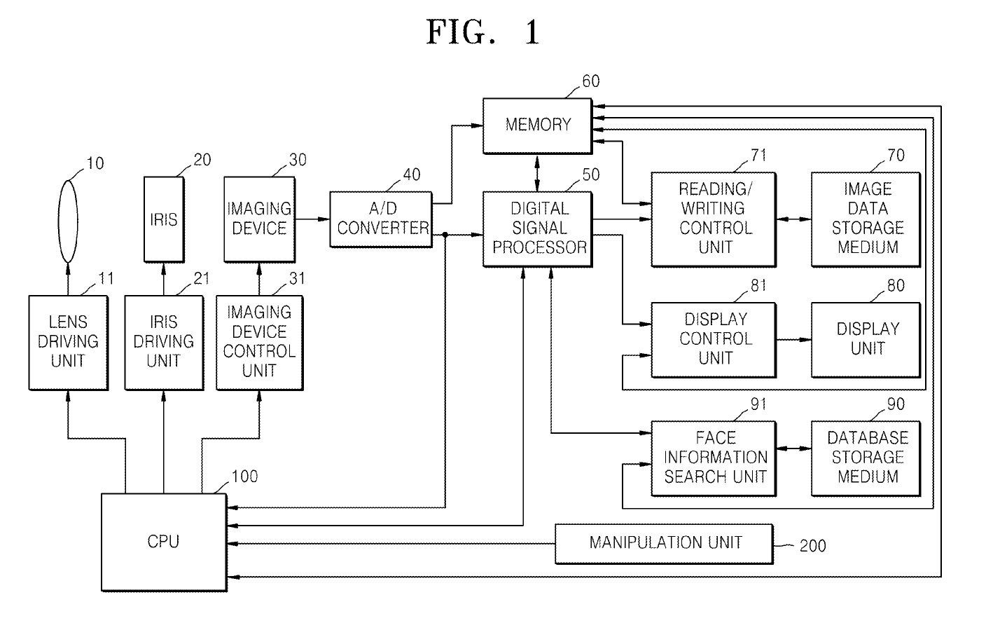

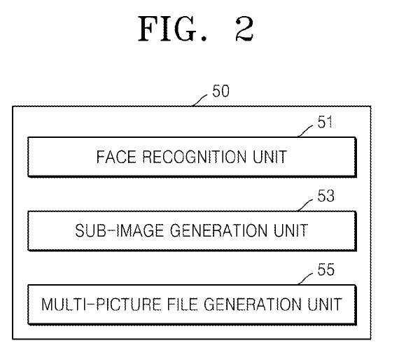

FIG. 1 is a block diagram of a digital photographing apparatus according to an embodiment of the present invention. FIG. 2 is a schematic block diagram of a portion of the digital photographing apparatus illustrated in FIG. 1, according to the embodiment of the present invention. All operations of a digital photographing apparatus according to an embodiment of the present invention are controlled by a central processing unit (CPU) 100. The digital photographing apparatus includes a manipulation unit 200 having a key generating an electrical signal in response to a user's instruction. An electrical signal generated by the manipulation unit 200 is transmitted to the CPU 100 so that the CPU 100 can control the digital photographing apparatus according to the electrical signal.

In a shooting mode, as an electrical signal generated in response to a user's instruction is input to the CPU 100, the CPU 100 analyzes the electrical signal and controls a lens driving unit 11, an iris driving unit 21, and an imaging device control unit 31, thus controlling the position of a lens 10, the degree of openness of an iris 20, and the sensitivity of an imaging device 30. The imaging device 30 generates data corresponding to incident light. An analog-to-digital converter (ADC) 40 converts the analog data received from the imaging device 30 to digital data. The ADC 40 may not be included depending on the characteristics of the imaging device 30.

Data output from the imaging device 30 may be provided to a digital signal processing unit 50 via a memory 60 or directly, bypassing the memory 60. The data output from the imaging device 30 may also be provided to the CPU 100. In the present embodiment, the memory 60 may include a read-only memory (ROM) or a random access memory (RAM). The digital signal processing unit 50 can perform digital signal processing, such as gamma correction, white balance correction, and the like. In addition, as will be described later with reference to FIG. 2, the digital signal processing unit 50 includes a face recognition unit 51, a sub-image generation unit 53, and a multi-picture file generation unit 55 that may increase user's convenience greatly. The face recognition unit 51, the sub-image generation unit 53, and the multi-picture file generation unit 55 may not be included in the digital signal processing unit 50, and may be separately formed or may be included in another component. That is, only the digital photographing apparatus may include the face recognition unit 51, the sub-image generation unit 53, and the multi-picture file generation unit 55. Functions of the face recognition unit 51, the sub-image generation unit 53, and the multi-picture file generation unit 55 will be described later.

Data output from the digital signal processing unit 50 may be transmitted to a display control unit 81 directly or via the memory 60. The display control unit 81 controls a display unit 80 in order to display an image on the display unit 80. In addition, image data output from the digital signal processing unit 50 may be input to a reading/writing control unit 71 directly or via the memory 60. The reading/writing control unit 71 stores the image data in an image data storage medium 70 in response to a signal received from the user or automatically. Alternatively, the reading/writing control unit 71 may read image data from a file stored in the image data storage medium 70, and provide the read data to the display control unit 81 via the memory 60 or via another path so that an image is displayed on the display unit 80. The image data storage medium 70 may be attachable to and detachable from the digital photographing apparatus. Alternatively, the image data storage medium 70 may be permanently attached to the digital photographing apparatus. A face information search unit 91 may search for face information in a database stored in a database storage medium 90. In addition, the face information read by the face information search unit 91 from the database storage medium 90 may be transferred to the digital signal processing unit 50 directly or via the memory 60.

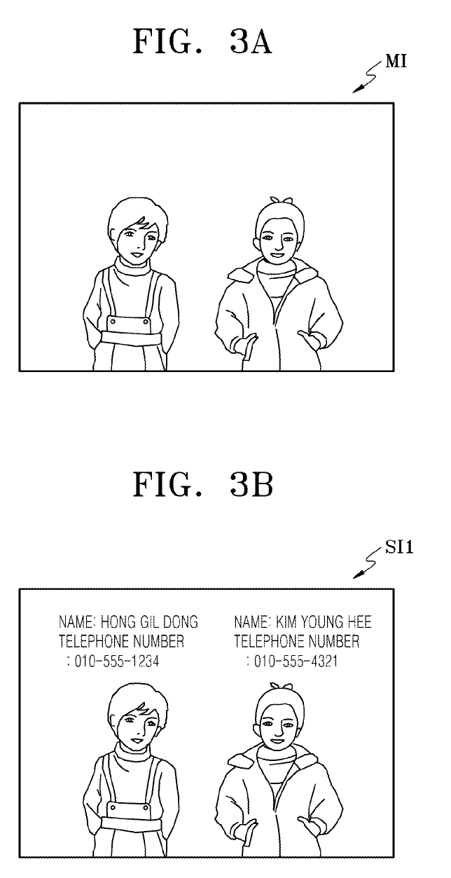

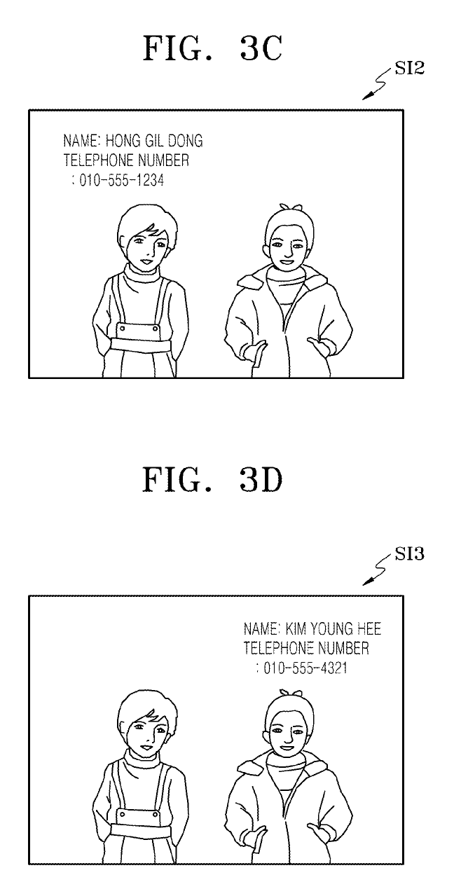

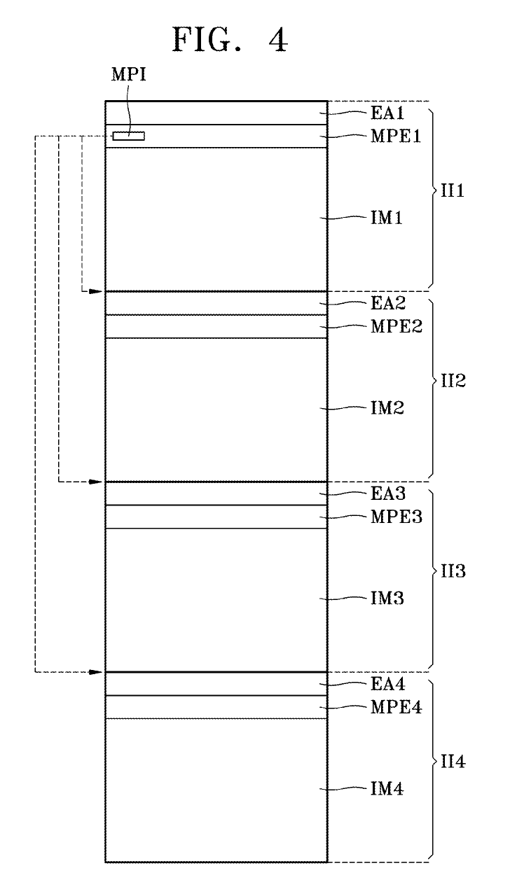

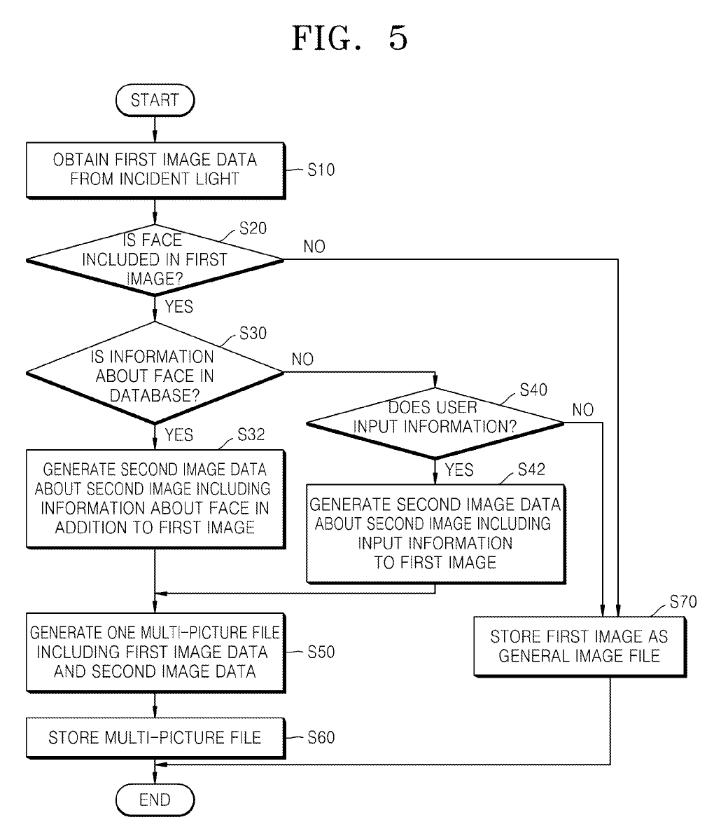

Functions of components in the digital photographing apparatus and operations of the digital photographing apparatus according to the present embodiment will be described with reference to FIGS. 3A through 3D, and FIG. 4.

FIG. 3A is a conceptual diagram schematically illustrating a first image MI acquired using the digital photographing apparatus illustrated in FIG. 1. FIGS. 3B through 3D are conceptual diagrams schematically illustrating second images generated by the digital photographing apparatus of FIG. 1. FIG. 4 is a conceptual diagram schematically illustrating a structure of a multi-picture file stored in the image data storage medium 70 of the digital photographing apparatus of FIG. 1.

The digital photographing apparatus of the present embodiment obtains first image data from light incident onto the imaging device 30. FIG. 3A schematically illustrates the first image MI, which corresponds to first image data. When the first image data is obtained, the face recognition unit 51 determines whether faces are included in the first image MI. The face recognition unit 51 may determine whether faces are included in the first image MI by using various methods. For example, since data about colors of faces may be stored in advance, it can be determined whether faces are included in the first image MI by determining whether there is data in the first image data corresponding to colors of a face. As another example, since data about pupils or shapes of eyes may be stored in advance, it can be determined whether faces are included in the first image MI by determining whether there is data in the first image data corresponding to pupils or shapes of eyes. As yet another example, since data about shapes of T-zones of faces formed by eyebrows (or eyes) and nose may be stored in advance, it can be determined whether faces are included in the first image MI by determining whether there is data in the first image data corresponding to T-zones.

When the face recognition unit 51 determines that a face is included in the first image MI, the face information search unit 91 determines whether information relating to the face included in the first image MI exists in the database stored in the database storage medium 90. When the information exists in the database, the face recognition unit 51 reads the information. For example, when the face recognition unit 51 determines that a face is included in the first image MI, the face recognition unit 51 analyzes characteristics of the face included in the first image MI and transmits the analyzed characteristics to the face information search unit 91. Characteristics of the face may include a ratio between distance between the eyes and size of the face, a ratio between size of the eyes and the size of the face, a ratio between distance from the brow to the lips and the size of face, face color, and shape of nose. The face information search unit 91 determines whether information relating to the face exists in the database stored in the database storage medium 90 using the above characteristics of the face, and if the information exists in the database, the face information search unit 91 reads the information.

When the face information search unit 91 reads the information relating to the face determined by the face recognition unit 51, the sub-image generation unit 53 generates second image data relating to a second image SI1 shown in FIG. 3B by adding a display of the read information onto the first image MI. As illustrated in FIG. 3B, the faces included in the first image MI are analyzed, and then sub-image generation unit 53 may generate the second image SI1 by adding the read information, which may include names and telephone numbers of two persons in the first image MI on the first image MI. Therefore, the sub-image generation unit 53 may generate a second image 512 or 513 that may be obtained by adding information relating to one of the two persons to the first image MI1 as shown in each of FIG. 3C and in FIG. 3D, and the sub-image generation unit 53 may also generate all second images illustrated in FIGS. 3B through 3D. Although, in FIGS. 3B through 3D, the displayed information relates to names and telephone numbers, the information may include various contents, for example, address or company information.

When the sub-image generation unit 53 generates at least one piece of second image data, the multi-picture file generation unit 55 may generate one multi-picture file including the first image data and the at least one second image data, and the generated multi-picture file may be stored in the image data storage medium 70. FIG. 4 is a conceptual diagram of a configuration of the multi-picture file. In more detail, in FIG. 4, data relating to four images may be included in one multi-picture file.

Each of first portion II1, second portion II2, third portion II3, and fourth portion II4 conceptually represents a portion including data relating to one of the four images. The first portion II1 corresponds to the first image MI illustrated in FIG. 3A, and the first image data is stored in region IM1. Exif information of the first image MI is stored in region EA1, and multi-picture format information and information relating to the first image are stored in region MPE1. The multi-picture format information may include information representing entire configurations of the four images stored in the first through fourth portions II1 to II4. The second portion II2 corresponds to the second image SI1 illustrated in FIG. 3B, and the second image data of the second image SI1 is stored in IM2. Exif information of the second image SI1 is stored in region EA2, and multi-picture format information and information relating to the second image are stored in region MPE2. A third portion II3 corresponds to the third image SI2 illustrated in FIG. 3C, and the fourth portion II4 corresponds to the fourth image SI3 illustrate in FIG. 3D. Configurations of the third and fourth portions II3 and II4 are similar to that of the second portion II2. Meanwhile, a multi-picture index MPI may be stored in the region MPE1 of the first portion II1. The multi-picture index MPI includes information about the entire configurations of the second images, for example, information about starting positions of the portions corresponding to the second to fourth images, as shown in FIG. 4.

The above configuration of the multi-picture file is exemplary. The Standardization Committee of the Camera & Imaging Products Association (CIPA) of Japan discloses a standard for multi-picture files in Standard CIPA DC-007-2009 entitled “Multi-Picture Format”, published Feb. 4, 2009, which is hereby incorporated by reference in its entirety herein.

According to the digital photographing apparatus of the present embodiment, when the first image MI, which corresponds to first image data, obtained by the photographing operation includes a person's face, information about the face is searched for in the database stored in the database storage medium 90. Then when corresponding information exists in the database, the second image SI1, which is obtained by adding the corresponding information onto the first image MI, and the second image data relating to the second image SI1 are generated. After that, one multi-picture file including the first image data and the second image data is generated and stored in the image data storage medium 70. Thus, a user of the digital photographing apparatus may recognize the information about the person included in the image even when time passes after obtaining the image. Since the multi-picture file includes the first image data, the user may check the first image MI, which does not include the information, whenever he/she wants. Moreover, since the first image data and the second image data are included in one multi-picture file, and not in separate files, the user may manage the images easily.

On the other hand, the face information search unit 91 may not find the information about the face included in the first image MI in the data base stored in the database storage medium 90. In this case, the sub-image generation unit 53 may generate second image data about the second image by adding information input from the user to the first image data.

In addition, when the face recognition unit 51 does not recognize any face in a first image, the first image may be stored as a general image file in the image data storage medium 70. Also, even when the first image includes a face, if the information about the face cannot be found in the data base stored in the database storage medium 90 and the user does not input the corresponding information into the digital photographing apparatus, the first image may be stored as a general image file in the image data storage medium 70.

FIG. 5 is a flowchart illustrating a method of controlling the digital photographing apparatus of FIG. 1, according to an embodiment of the present invention.

Referring to FIG. 5, in operation S10, first image data is obtained from light incident onto the imaging device 30, and in operation S20, it is determined whether a face is included in a first image of the first image data. When it is determined that a face is not included in the first image, in operation S70, the first image is stored as a general image file. When it is determined that a face is included in the first image, in operation S30, it is determined whether information about the face included in the first image exists in the database stored in the database storage medium 90.

When it is determined that information about the face is stored in the database, in operation S32, second image data relating to a second image that is obtained by adding a display of the information in the first image is generated. In addition, in operation S50, one multi-picture file including both the first image data and the second image data is generated, and in operation S60, the generated multi-picture file is stored in the image data storage medium 70.

When it is determined that information about the face included in the first image does not exist in the database in operation S30, it is determined whether information is input by the user in operation S40. When the user inputs the information, the second image data relating to the second image, which displays the information input from the user onto the first image, is generated in operation S42. In addition, in operation S50, one multi-picture file including both the first image data and the second image data is generated, and in operation S60, the generated multi-picture file is stored in the image data storage medium 70.

When information is not input from the user in operation S40 or when it is determined that a face is not included in the first image in operation S20, the first image is stored as a general image file in operation S70.

According to the method of controlling the digital photographing apparatus of the present embodiment, when a face is included in a first image obtained by a photographing operation, information relating to the face is searched for in the database stored in the database storage medium 90, and then, when corresponding information exists in the database, second image data of a second image that displays the information on the first image is generated. After that, one multi-picture file including the first image data and the second image data is generated and stored in the image data storage medium 70. Therefore, when time passes after taking the image, the user may easily check information about a person included in the multi-picture file. Since the multi-picture file includes the first image data, the user may always check the first image, which does not display information. Moreover, since the first image data and the second image data are included in one multi-picture file, and not in separate files, the user may easily manage the images.

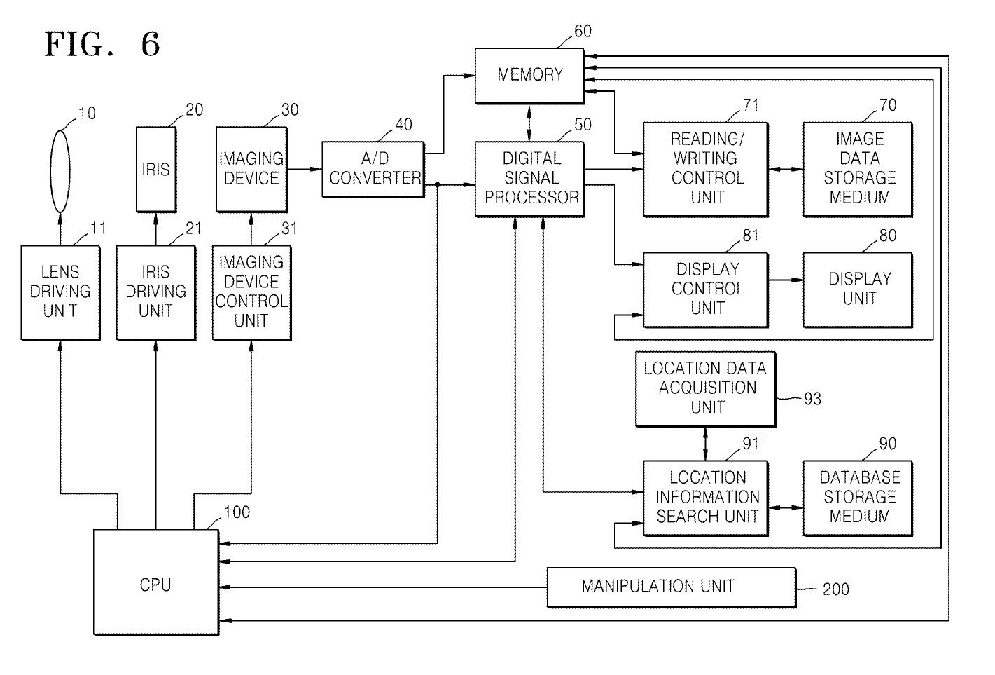

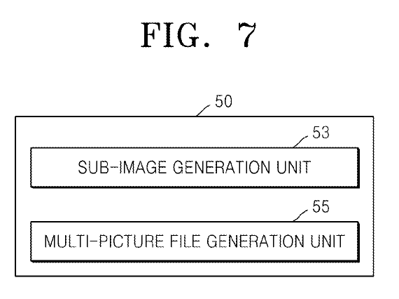

FIG. 6 is a block diagram of a digital photographing apparatus according to another embodiment of the present invention, and FIG. 7 is a schematic block diagram of a portion of the digital photographing apparatus illustrated in FIG. 6, according to the embodiment of the present invention.

The digital photographing apparatus of the present embodiment is different from the digital photographing apparatus according to the previous embodiment described with reference to FIGS. 1 and 2 in that the digital photographing apparatus of the present embodiment includes a location information search unit 91′ instead of including the face information search unit 91 and further includes a location data acquisition unit 93, and in that the database storage medium 90 stores database including information about locations. In addition, the digital signal processing unit 50 may not include the face recognition unit. Descriptions about elements of the digital photographing apparatus of the present embodiment that are the same as those of the digital photographing apparatus illustrated in FIGS. 1 and 2 are not provided.

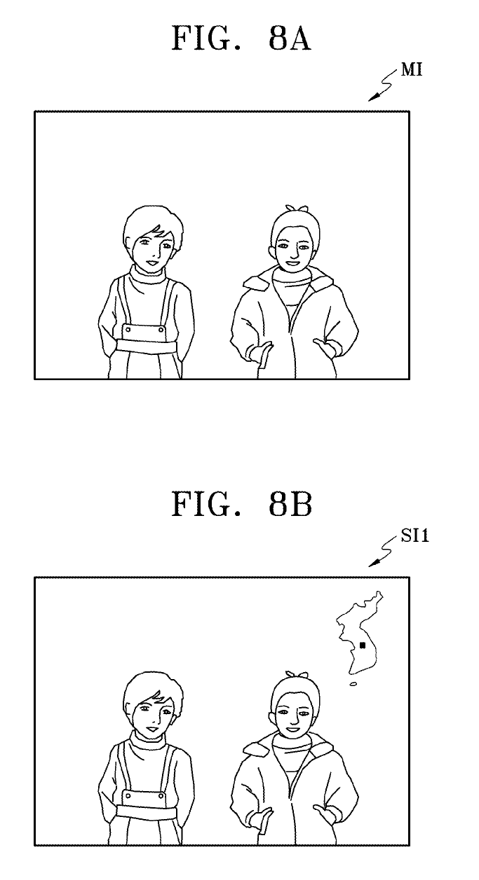

Functions of the elements in the digital photographing apparatus and operations of the digital photographing apparatus according to the present embodiment will be described with reference to FIGS. 8A and 8B. FIG. 8A is a conceptual diagram schematically illustrating a first image acquired using the digital photographing apparatus of FIG. 6, and FIG. 8B is a conceptual diagram schematically illustrating a second image generated by the digital photographing apparatus of FIG. 6.

In the digital photographing apparatus of the present embodiment, first image data is obtained from light incident onto the imaging device 30. FIG. 8A is a conceptual diagram schematically illustrating a first image MI obtained from the first image data. The location data acquisition unit 93 acquires data of the location where the first image data is obtained. The location data acquisition unit 93 may acquire the location information by using a global positioning system (GPS) signal.

The location information search unit 91′ searches for information corresponding to the location data acquired by the location data acquisition unit 93 in the database stored in the database storage medium 90, and when the information exists in the database, the location information search unit 91′ reads the corresponding information from the database.

When the location information search unit 91′ reads the information corresponding to the location data acquired by the location data acquisition unit 93, the sub-image generation unit 53 generates second image data of a second image by adding a display of the read information on the first image MI illustrated in FIG. 8B. In FIG. 8B, the location where the first image data is obtained is represented as a diagram, for example, when the first image data is obtained in Seoul, South Korea, the location where the first image data is obtained may be represented by a dot in an image of South Korea as shown in FIG. 8B. However, the present invention is not limited to the above example, and the location may be represented in various ways, for example, as letters.

When the sub-image generation unit 53 generates the second image data, the multi-picture file generation unit 55 may generate one multi-picture file including both the first image data and the second image data, and the multi-picture file may be stored in the image data storage medium 70. The configuration of the multi-picture file is described above with reference to FIG. 4.

According to the digital photographing apparatus of the present embodiment, the information about the location where the first image MI is obtained by the photographing operation may be found in the database stored in the database storage medium 90. In addition, when the information exists in the database, the second image data relating to the second image SI1, which displays the information on the first image MI, is generated, and then one multi-picture file including the first image data and the second image data is generated and stored in the image data storage medium 70. Therefore, after a long time passes since the image has been captured, the user may check information about the location where the image is obtained. Since the first image data is included in the multi-picture file, the user may check the first image MI, which is the original image without the information displayed. Moreover, since the first image data and the second image data are included in one multi-picture file, not in separate files, the user may manage the images easily.

On the other hand, the location information search unit 91′ may not find the information about the location where the first image is obtained in the database stored in the database storage medium 90. In this case, the sub-image generation unit 53 may generate the second image data relating to the second image SI1, by adding information input from the user on the first image MI.

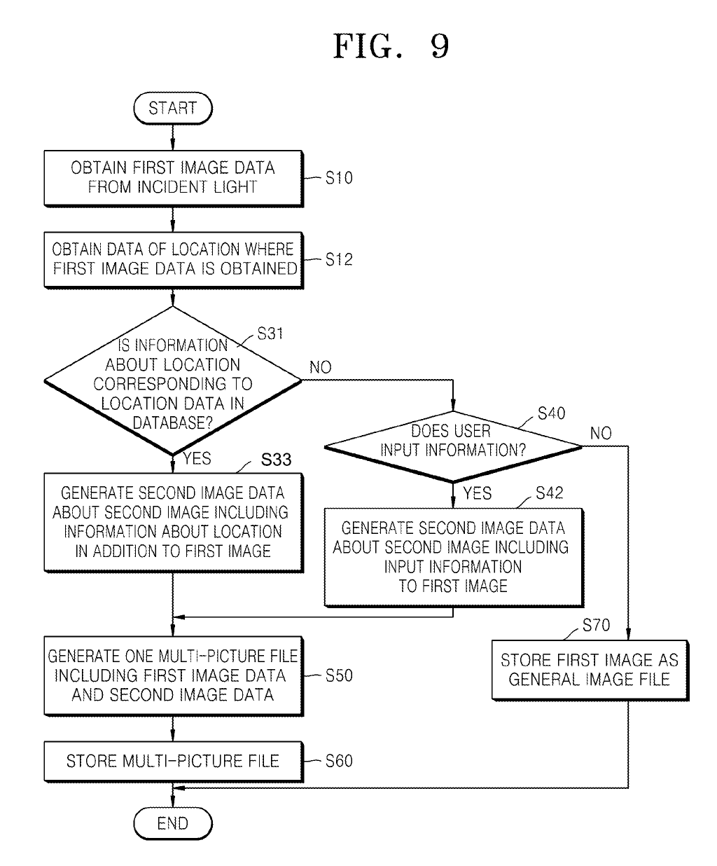

FIG. 9 is a flowchart illustrating a method of controlling the digital photographing apparatus illustrated in FIG. 6, according to an embodiment of the present invention.

Referring to FIG. 9, in operation S10, first image data is obtained from light incident onto the imaging device 30, and then, in operation S12, data corresponding to the location where the first image data is obtained is acquired. The operations of S10 and S12 may be performed simultaneously.

After that, in operation S31, it is determined whether information about the location included in the location data exists in the database stored in the database storage, and when the information exists in the database, second image data of second image that displays the location information on the first image is generated in operation S33. In addition, in operation S50, a multi-picture file including both the first image data and the second image data is generated, and then in operation S60, the generated multi-picture file is stored in the image data storage medium 70.

When the information about the location included in the location data does not exist in the database, it is determined whether the user inputs the information in operation S40. When the user inputs the information, the second image data of the second image, which displays the information input from the user on the first image, is generated in operation S42, and then the multi-picture file including the first image data and the second image data is generated in operation S50 and the generated multi-picture file is stored in the image data storage medium 70 in operation S60. When the user does not input the information, the first image is stored as a general image file in the image data storage medium in operation S70.

According to the method of controlling the digital photographing apparatus of the present embodiment, the information about the location where the first image is obtained is searched for in the database stored in the database storage medium 70, and when the information exists in the database, the second image data of the second image, which displays the information on the first image, is generated. In addition, one multi-picture file including the first image data and the second image data is generated and stored in the image data storage medium 90. Therefore, after a long time passes since the image has been captured, the user may check information about the location where the image is obtained. Since the first image data is included in the multi-picture file, the user may check the first image MI, which is the original image without the information displayed. Moreover, since the first image data and the second image data are included in one multi-picture file, not in separate files, the user may manage the images easily.

A digital photographing apparatus according to another embodiment of the present invention will be described with reference to FIG. 1. However, unlike the digital photographing apparatus shown in FIG. 1, the digital photographing apparatus of the present embodiment includes an information search unit instead of including the face information search unit 91, and may not include the face recognition unit 51 unlike the digital photographing apparatus shown in FIG. 2. Operations of the digital photographing apparatus will be described as follows.

When the first image data is acquired from the light incident onto the imaging device 30, the sub-image generation unit 53 generates second image data relating to the second image that represents information in addition to the first image included in the first image data. In addition, the multi-picture file generation unit 55 generates one multi-picture file including the first image data and the second image data and stores the generated multi-picture file in the image data storage medium 70. Here, when the sub-image generation unit 53 generates the second image data, the sub-image generation unit 53 may generate the second image data including the second image, in which the information read by the information search unit from the database storage medium 90 is displayed on the first image. When the information search unit does not find the information corresponding to the first image in the database storage medium 90, the sub-image generation unit 53 may generate the second image data relating to the second image that represents information input from the user on the first image. Here, the information may include name or address of the person included in the image, the location where the first image is captured, weather, etc., as described in the above embodiments.

According to the digital photographing apparatus of the present embodiment, the information about the first image obtained by the photographing operation is searched for in the database stored in the database storage medium 90, and when corresponding information exists in the database, the second image data relating to the second image, which displays the information on the first image MI, is generated. In addition, one multi-picture file including the first image data and the second image data is generated and stored in the image data storage medium 70. Therefore, after a long time has passed since the image has been captured, the user may check the information about the image. Since the first image data is included in the multi-picture file, the user may always check the first image MI, which is the original image without the information. Moreover, since the first image data and the second image data are included in one multi-picture file, not in separate files, the user may manage the images easily.

A method of controlling the digital photographing apparatus according to the present embodiment will be described briefly as follows. First image data is obtained from light incident onto the imaging device 30, and then the second image data relating to a second image that displays the information on the first image of the first image data is generated. After that, one multi-picture file including the first image data and the second image data is generated and stored in the image data storage medium. Here, in the process of generating the second image data, the second image data relating to the second image, which displays the information read from the database on the first image, may be generated. Otherwise, the second image data relating to the second image may be generated as described elsewhere herein. According to the method of controlling the digital photographing apparatus, the user may easily recall memories of the corresponding image by checking the information. In this case, the first image, which is the original image, to which the additional information is not added, may be recovered from the first image data included in the multi-picture file.

According to the digital photographing apparatus, the method of controlling the digital photographing apparatus, and the recording medium storing the program to implement the controlling method, second image data is generated by adding the information to the first image of the first image data, and then the first image data and the second image data are stored as one file so as to improve convenience of the user.

In general, an apparatus for performing the methods according to the embodiments of the present invention may be implemented using any general purpose computing device or devices. Any of the computing devices may comprise a processor, a memory for storing program data and executing the program data, a permanent storage such as a disk drive, a communications port for handling communications with external devices, and user interface devices, including a display, keyboard, mouse, etc. When software modules are involved, these software modules may be stored as program instructions executable on the processor on a computer-readable storage medium, where the program instructions stored on this medium can be read by the computing device, stored in the memory, and executed by the processor. Examples of the storage medium include magnetic storage media (e.g., floppy disks, hard disks, or magnetic tape), optical recording media (e.g., CD-ROMs or digital versatile disks (DVDs)), and electronic storage media (e.g., integrated circuits (IC's), ROM, RAM, EEPROM, or flash memory). The storage medium may also be distributed over network-coupled computing devices so that the program instructions are stored and executed in a distributed fashion.

The present invention may be described in terms of functional block components and various processing steps. Such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices. Similarly, where the elements of the present invention are implemented using software programming or software elements the invention may be implemented with any programming or scripting language such as C, C++, Java, assembler, or the like, with the various algorithms being implemented with any combination of data structures, objects, processes, routines or other programming elements. Furthermore, the present invention could employ any number of conventional techniques for electronics configuration, signal processing and/or control, data processing and the like. The word mechanism is used broadly and is not limited to mechanical or physical embodiments, but can include software routines in conjunction with processors, etc.

The particular implementations shown and described herein are illustrative examples of the invention and are not intended to otherwise limit the scope of the invention in any way. For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”.

As these embodiments of the present invention are described with reference to illustrations, various modifications or adaptations of the methods and or specific structures described may become apparent to those skilled in the art. All such modifications, adaptations, or variations that rely upon the teachings of the present invention, and through which these teachings have advanced the art, are considered to be within the spirit and scope of the present invention. Hence, these descriptions and drawings should not be considered in a limiting sense, as it is understood that the present invention is in no way limited to only the embodiments illustrated.

It will be recognized that the terms “comprising,” “including,” and “having,” as used herein, are specifically intended to be read as open-ended terms of art. The use of the terms “a” and “and” and “the” and similar referents in the context of describing the invention (especially in the context of the following claims) are to be construed to cover both the singular and the plural. Furthermore, recitation of ranges of values herein are merely intended to serve as a shorthand method of referring individually to each separate value falling within the range, unless otherwise indicated herein, and each separate value is incorporated into the specification as if it were individually recited herein. Finally, the steps of all methods described herein can be performed in any suitable order unless otherwise indicated herein or otherwise clearly contradicted by context.

What is claimed is:

1. A digital photographing apparatus comprising:
an imaging device that generates first image data from incident light;
a face recognition unit that determines whether a face is included in a first image of the first image data generated by the imaging device;
a database storage medium that stores a database having information about faces;
a face information search unit that searches for information about the face included in the first image of the first image data generated by the imaging device from the database stored in the database storage medium;
a sub-image generation unit that generates second image data including a second image that is obtained by adding the information found by the face information search unit onto the first image;
a multi-picture file generation unit that generates one multi-picture file including the first image data generated by the imaging device and the second image data generated by the sub-image generation unit; and
an image data storage medium that stores the multi-picture file generated by the multi-picture file generation unit.

2. The digital photographing apparatus of claim 1, wherein, when the face information search unit does not find information about the face included in the first image of the first image data generated by the imaging device from the database stored in the database storage medium, the sub-image generation unit generates second image data of a second image obtained by adding information input from a user of the digital photographing apparatus to the first image.

3. A digital photographing apparatus comprising:
an imaging device that generates first image data from incident light;
a location data acquisition unit that acquires data of a location where the imaging device obtains the first image data;
a database storage medium that stores a database including information about locations;
a location information search unit that searches for information about a location corresponding to the location data acquired by the location data acquisition unit from the database stored in the database storage medium;
a sub-image generation unit that generates second image data of a second image that is obtained by adding the information found by the location information search unit onto the first image of the first image data generated by the imaging device;
a multi-picture file generation unit that generates one multi-picture file including the first image data generated by the imaging device and the second image data generated by the sub-image generation unit; and
an image data storage medium that stores the multi-picture file generated by the multi-picture file generation unit.

4. The digital photographing apparatus of claim 3, wherein when the location information search unit does not find information about a location corresponding to the location data acquired by the location data acquisition unit from the database stored in the database storage medium, the sub-image generation unit generates second image data of a second image obtained by adding information input from a user of the digital photographing apparatus onto the first image.

5. A digital photographing apparatus comprising:
an imaging device that generates first image data from incident light;
a database storage medium that stores a database including information;
an information search unit that searches for information related to a first image in the first image data generated by the imaging device from the database stored in the database storage medium;
a sub-image generation unit that generates second image data of a second image that is obtained by adding the information found by the information search unit onto the first image of the first image data generated by the imaging device;
a multi-picture file generation unit that generates one multi-picture file including the first image data generated by the imaging device and the second image data generated by the sub-image generation unit; and
an image data storage medium that stores the multi-picture file generated by the multi-picture file generation unit.

6. The digital photographing apparatus of claim 5, wherein when the information search unit does not find information about the first image from the database stored in the database storage medium, the sub-image generation unit generates second image data of a second image obtained by adding information input from a user of the digital photographing apparatus onto the first image.

7. A method of controlling a digital photographing apparatus, the method comprising:
obtaining first image data from light incident onto an imaging device;
determining whether a face is included in a first image of the first image data;
when a face is included in the first image, determining whether information about the face included in the first image exists in a database; and
when information about the face exists in the database, generating second image data relating to a second image that is obtained by adding the information onto the first image, generating one multi-picture file including the first image data and the second image data, and storing the multi-picture file in an image data storage medium.

8. The method of claim 7, wherein when information about the face does not exist in the database in the step of determining whether information about the face exists in the database, further comprising:
generating second image data about a second image that is obtained by adding information input from a user of the digital photographing apparatus onto the first image;
generating one multi-picture file including the first image data and the second image data; and
storing the multi-picture file in an image data storage medium.

9. A computer readable storage medium having stored thereon a program executable by a processor for performing a method of controlling a digital photographing apparatus, the method comprising:
obtaining first image data from light incident onto an imaging device;
determining whether a face is included in a first image of the first image data;
when a face is included in the first image, determining whether information about the face included in the first image exists in a database; and
when information about the face exists in the database, generating second image data relating to a second image that is obtained by adding the information onto the first image, generating one multi-picture file including the first image data and the second image data, and storing the multi-picture file in an image data storage medium.

10. The computer readable storage medium of claim 9, wherein when information about the face does not exist in the database in the step of determining whether information about the face exists in the database, further comprising:
generating second image data about a second image that is obtained by adding information input from a user of the digital photographing apparatus onto the first image;
generating one multi-picture file including the first image data and the second image data; and
storing the multi-picture file in an image data storage medium.

11. A method of controlling a digital photographing apparatus, the method comprising:
obtaining first image data from light incident onto an imaging device;
obtaining data of a location where the first image data is obtained;
determining whether information about a location corresponding to the location data exists in a database; and
when information about the location exists in the database, generating second image data relating to a second image that is obtained by adding the information onto the first image, generating one multi-picture file including the first image data and the second image data, and storing the multi-picture file in an image data storage medium.

12. The method of claim 11, wherein when information about the location does not exist in the database in the step of determining whether information about the location exists in the database, further comprising:
generating second image data about a second image that is obtained by adding information input from a user of the digital photographing apparatus onto the first image;
generating one multi-picture file including the first image data and the second image data; and
storing the multi-picture file in an image data storage medium.

13. A computer readable storage medium having stored thereon a program executable by a processor for performing a method of controlling a digital photographing apparatus, the method comprising:
obtaining first image data from light incident onto an imaging device;
obtaining data of a location where the first image data is obtained;
determining whether information about a location corresponding to the location data exists in a database; and
when information about the location exists in the database, generating second image data relating to a second image that is obtained by adding the information onto the first image, generating one multi-picture file including the first image data and the second image data, and storing the multi-picture file in an image data storage medium.

14. The computer readable storage medium of claim 13, wherein when information about the location does not exist in the database in the step of determining whether information about the location exists in the database, further comprising:
generating second image data about a second image that is obtained by adding information input from a user of the digital photographing apparatus onto the first image;
generating one multi-picture file including the first image data and the second image data; and
storing the multi-picture file in an image data storage medium.

15. A method of controlling a digital photographing apparatus, the method comprising:
obtaining first image data from light incident onto an imaging device;
generating second image data about a second image that is obtained by adding information onto the first image;
generating one multi-picture file including the first image data and the second image data; and
storing the multi-picture file in an image data storage medium.

16. The method of claim 15, wherein the generating of the second image data comprises generating the second image data about the second image obtained by adding information read from a database onto the first image.

17. The method of claim 15, wherein the generating of the second image data comprises generating the second image data about the second image obtained by adding information input from a user of the digital photographing apparatus onto the first image.

18. A computer readable storage medium having stored thereon a program executable by a processor for performing a method of controlling a digital photographing apparatus, the method comprising:
obtaining first image data from light incident onto an imaging device;
generating second image data about a second image that is obtained by adding information onto the first image;
generating one multi-picture file including the first image data and the second image data; and
storing the multi-picture file in an image data storage medium.

19. The computer readable storage medium of claim 18, wherein the generating of the second image data comprises generating the second image data about the second image obtained by adding information read from a database onto the first image.

20. The computer readable storage medium of claim 18, wherein the generating of the second image data comprises generating the second image data about the second image obtained by adding information input from a user of the digital photographing apparatus onto the first image.
